(19) United States
(12) Patent Application Publication
(10) Pub. No.: US 2009/0265708 A1
(43) Pub. Date: Oct. 22, 2009

(54) Information Processing Apparatus and Method of Controlling Information Processing Apparatus

(75) Inventor: Hiroshi Nakajima, Nishitokyo-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Kabushiki Kaisha Toshiba, Tokyo (JP)

(21) Appl. No.: 12/337,427

(22) Filed: Dec. 17, 2008

(30) Foreign Application Priority Data
Apr. 18, 2008 (JP) 2008-109353

(51) Int. Cl. G06F 9/455

(52) U.S. Cl. 718/1

(57) ABSTRACT

According to one embodiment, an information processing apparatus in which virtual machine run under a hypervisor, includes a device manager configured to create a device model including information that is used when assigning an I/O device to the virtual machine in accordance with a device profile and an arrangement of I/O devices, and an address conversion circuit configured to perform address conversion for the virtual machine to make an MMIO access to the assigned I/O device and to perform address conversion to conduct a DMA transfer between the assigned I/O device and the virtual machine, wherein the hypervisor assigns the I/O device to the virtual machine based on the device model, and the virtual machine utilizes, when making the MMIO access to the assigned I/O device or conducting the DMA transfer with the assigned I/O device, the address conversion circuit to make the access or conducts the DMA transfer.

### CROSS-REFERENCE TO RELATED APPLICATIONS

This application is based upon and claims the benefit of priority from Japanese Patent Application No. 2008-109353, filed Apr. 18, 2008, the entire contents of which are incorporated herein by reference.

### BACKGROUND

1. Field

One embodiment of the invention relates to the operation of a virtual machine on a hypervisor, especially to an information processing apparatus in which the virtual machine performs communication with an I/O device, as well as a method of controlling such an information processing apparatus.

2. Description of the Related Art

The virtual machine technology for separating the software environment (virtual machine) used by the user from the hardware has been receiving attention.

In the virtual machine technology, a hypervisor performs arbitration between the hardware and the virtual machine.

Conventionally, a virtual machine monitor (hypervisor) runs on a personal computer, and a virtual machine is executed under this virtual machine monitor. The I/O device of the virtual machine is executed by emulation of a virtual device, and the display contents of the virtual device are presented on a display by way of a physical device (see Jpn. Pat. Appln. KOKAI Publication No. 2007-323354).

With the conventional virtualization technology, graphics are emulated on a virtual device, and therefore drawing cannot be performed as quickly as on a hardware device. Furthermore, because I/O devices are also realized by emulation, it is difficult to operate them at high speed. In addition, the virtual machine needs to be installed in a manner suitable for the structure of the emulator, and the created images can be operated only on the virtual machine monitor.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing the structure of a client computer and a server that constitutes an information processing apparatus according to an embodiment of the present invention;

FIG. 2 is an exemplary block diagram showing the system structure of the client computer illustrated in FIG. 1;

FIG. 3 is an exemplary block diagram describing the structure of a device manager that controls the devices as well as its relationship with a virtual machine and a virtual machine monitor;

FIG. 4 is an exemplary flowchart showing the operations from the startup of the client computer through the implementation of the virtual machine;

FIG. 5 is an exemplary flowchart showing the operations from the startup of the client computer through the implementation of the virtual machine;

FIG. 6 is an exemplary diagram showing the operations from the startup of the client computer through the implementation of the virtual machine;

FIG. 7 is an exemplary diagram showing the operations from the startup of the client computer through the implementation of the virtual machine;

FIG. 8 is an exemplary diagram showing an example of a device profile;

FIG. 9 is an exemplary diagram showing an example of a device model structure list;

FIG. 10 is an exemplary diagram showing an exemplary structure of a virtual device model;

FIG. 11 is an exemplary diagram showing an example of an address space conversion; and

FIG. 12 is an exemplary diagram showing an example of a server operating as a virtual machine on a virtual machine monitor.

### DETAILED DESCRIPTION

Various embodiments according to the invention will be described hereinafter with reference to the accompanying drawings. In general, according to one embodiment of the invention, an information processing apparatus in which virtual machines including a client virtual machine run under a hypervisor, comprises a device manager configured to create a device model including information that is used when assigning an I/O device to the client virtual machine in accordance with a device profile and an arrangement of I/O devices provided in the information processing apparatus, and a semiconductor circuit having an address conversion circuit configured to perform address conversion for the client virtual machine to make an MMIO access to the assigned I/O device and to perform address conversion to conduct a DMA transfer between the assigned I/O device and the client virtual machine, wherein the hypervisor assigns the I/O device to the client virtual machine based on the device model, and the client virtual machine utilizes, when making the MMIO access to the assigned I/O device or conducting the DMA transfer with the assigned I/O device, the address conversion circuit to make the access or conducts the DMA transfer.

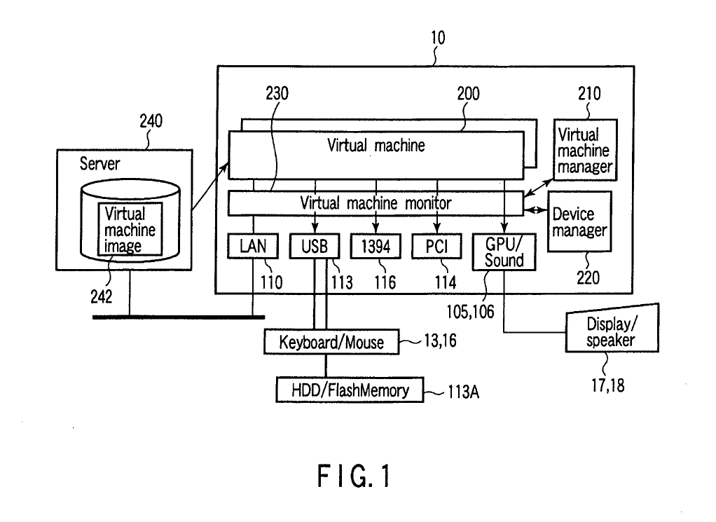

FIG. 1 is a block diagram showing a structure of a system including a client computer and a server as an information processing apparatus according to an embodiment of the present invention.

As illustrated in FIG. 1, a client computer 10 comprises a virtual machine monitor (hypervisor) 230, a virtual machine manager 210, a device manager 220, a virtual machine 200, a LAN controller 110, a USB controller 113, an IEEE 1394 controller 116, a PCI device 114, a graphics processor unit (GPU) 105, sound controller 106, and the like.

The virtual machine monitor 230 controls the hardware such as the LAN controller 110, the USB controller 113, the IEEE 1394 controller 116, the PCI device 114 and the graphics processor unit (GPU) 105/sound controller 106, and allocates resources to a virtual machines 200 operating under the virtual machine monitor 230. In addition, the virtual machine monitor 230 divides the execution schedules of the virtual machines 200 and I/O request from the virtual machines among the hardware devices.

The virtual machine manager 210 controls the boot or the like of the virtual machine 200 running under the virtual machine monitor 230. The device manager 220 controls the hardware before the boot of the virtual machine 200. The device manager 220 also controls the communication with the I/O device after the virtual machine 200 is booted.

It should be noted that the virtual machine monitor 230, the virtual machine manager 210, the device manager 220, and the virtual machine 200 are software modules running on the processor.

The LAN controller 110 is a network interface for connecting the computer to a local area network (LAN). The USB controller 113 controls communication with USB devices connected to the USB bus, such as a keyboard 13, a touchpad 16, and the HDD/flash memory 113A. The IEEE 1394 controller 116 controls communication with external devices connected to the IEEE 1394 bus. The PCI device 114 is a device connected to the PCI bus. The GPU 105 is a display controller that controls the display. The GPU 105 includes a video memory (VRAM) and generates a video signal for forming a display image to be displayed from the display data rendered in the video memory by an OS/application program. The sound controller 106 is a sound source device and outputs audio data that is to be reproduced to a speaker.

A server 240 stores in its HDD 241 a software image 242 that is used at the boot of a virtual machine. The software image 242 is the same as the image of a partition of the hard disk (HDD) that is necessary for the virtual machine to operate. For this reason, this software image 242 is regarded as the HDD itself from the virtual machine side, even when it is connected by the LAN.

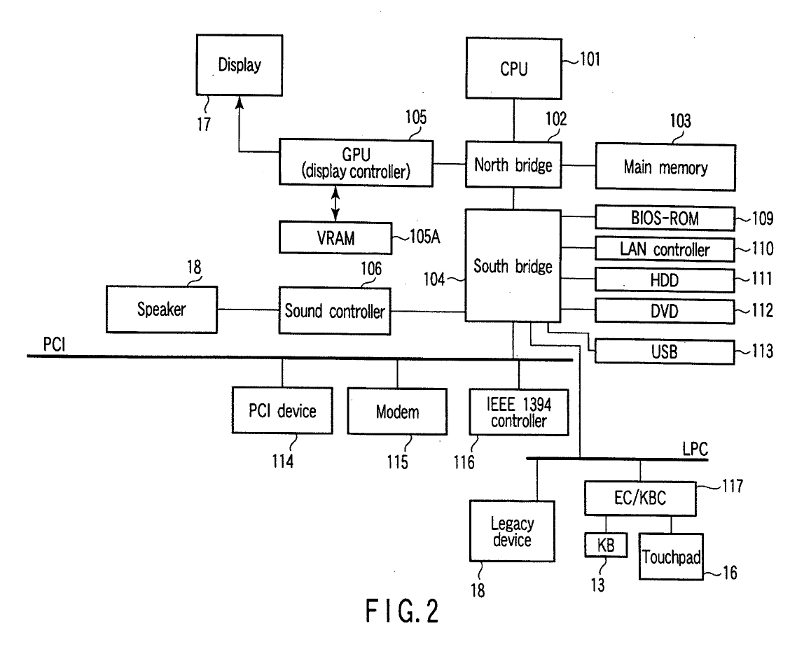

Next, the system structure of the computer according to the embodiment will be explained with reference to FIG. 2.

As illustrated in FIG. 2, the computer comprises a CPU 101, a north bridge 102, a main memory 103, a south bridge 104, a graphics processing unit (GPU) 105, a video memory (VRAM) 105A, a sound controller 106, a BIOS-ROM 109, a LAN controller 110, a hard disk drive (HDD) 111, a DVD drive 112, a PCI device 114, a modem 115, an IEEE 1394 controller 116, an embedded controller/keyboard controller IC (EC/KBC) 117, and the like.

The CPU 101 is a processor that controls the operation of the computer 10 and executes various application programs that are loaded from the hard disk drive (HDD) 111 onto the main memory 103. The CPU 101 also executes a basic input/output system (BIOS) stored in the BIOS-ROM 109. The BIOS is a program for controlling the hardware.

The north bridge 102 is a bridge device bridging a portion between the local bus of the CPU 101 and the south bridge 104. The north bridge 102 contains a memory controller for controlling accesses to the main memory 103. Further, the north bridge 102 has a function of executing communication with the GPU 105 by way of a serial bus of the PCI Express standard or the like.

The GPU 105 is a display controller that controls the display 117 that is used as a display monitor of the computer 10. The display signal generated by the GPU 105 is sent to the display 117.

The south bridge 104 controls devices on the low pin count (LPC) bus including a legacy device 18 and devices on the Peripheral Component Interconnect (PCI) bus. Further, the south bridge 104 contains an Integrated Drive Electronics (IDE) controller to control the hard disk drive (HDD) 111 and the DVD drive 112. Further, the south bridge 104 has a function of performing communication with the sound controller 106.

The sound controller 106 is a sound source device and outputs audio data that is to be reproduced to a speaker 18. The USB controller 113 executes communication with external devices by way of a USB-standard serial bus. The IEEE 1394 controller 116 performs communication with external devices by way of an IEEE 1394 serial bus. The modem 115 is a signal converter to realize data communication over analog lines such as telephone lines.

The embedded controller/keyboard controller IC (EC/KBC) 116 is a one-chip microcomputer in which an embedded controller designed for electrical power management and a keyboard controller designed for controlling the keyboard (KB) 13 and the touchpad 16 are integrated. This embedded controller/keyboard controller IC (EC/KBC) 116 turns the computer 10 on/off in accordance with the user's operation of the power switch. Furthermore, the embedded controller/keyboard controller IC (EC/KBC) 116 is provided with a function of communicating with a remote control unit interface 20.

Among the above devices, the GPU 105, the LAN controller 110, the integrated drive electronics (IDE) controller to which the the HDD 111 and the DVD are connected, the USB controller 113, the IEEE 1394 controller 116, the modem 115, and other PCI devices 114 are connected as PCI devices. These devices are accessed from the CPU 101 and operated according to the PCI standards.

The computer of this embodiment supports Intel® directed I/O technology (VT-d). VT-d is a technology for virtualizing an I/O device. VT-d pertains especially to the chipset, the I/O controller and the memory controller.

Several methods have been suggested for virtualization of an I/O device. For the VT-d supporting device of the present embodiment, the I/O device is virtualized by use of a pass-through model. With a pass-through model, the virtual machine monitor can directly assign the I/O device to a virtual machine. For example, a SCSI card or a network card may be prepared and assigned to each virtual machine. The device manager implements an initialization control on the PCI devices.

The boot of the virtual machine and the assignment of the I/O device will now be explained.

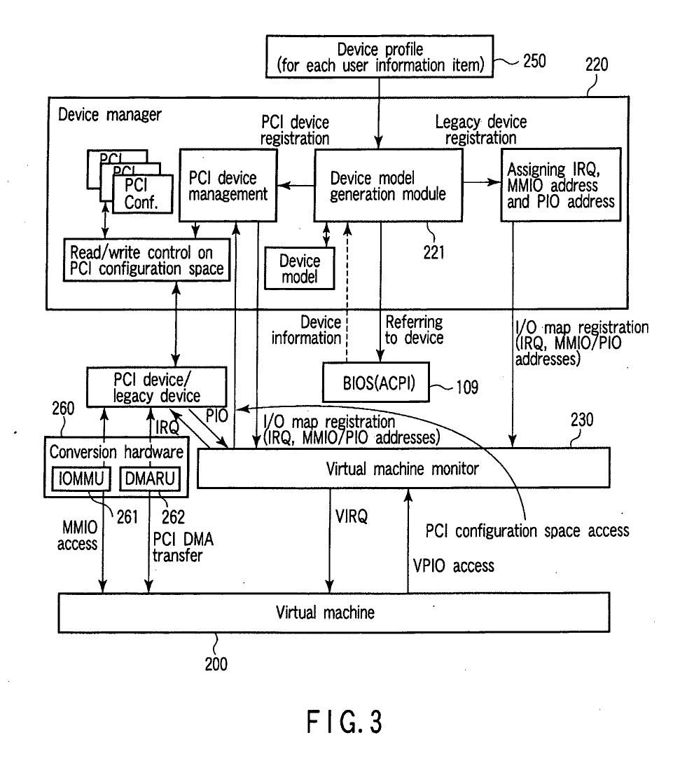

FIG. 3 indicates the structure of the device manager that controls the hardware device and its relationship with the virtual machine and the virtual machine monitor.

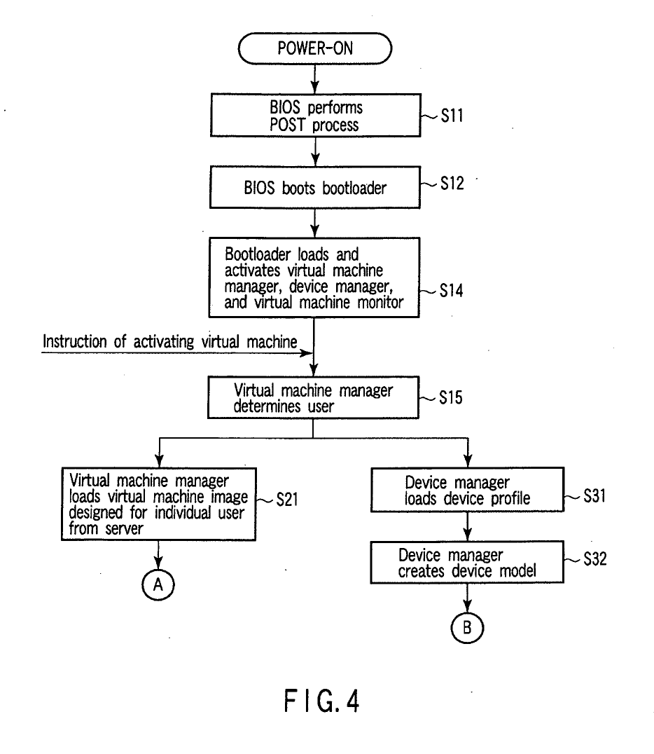

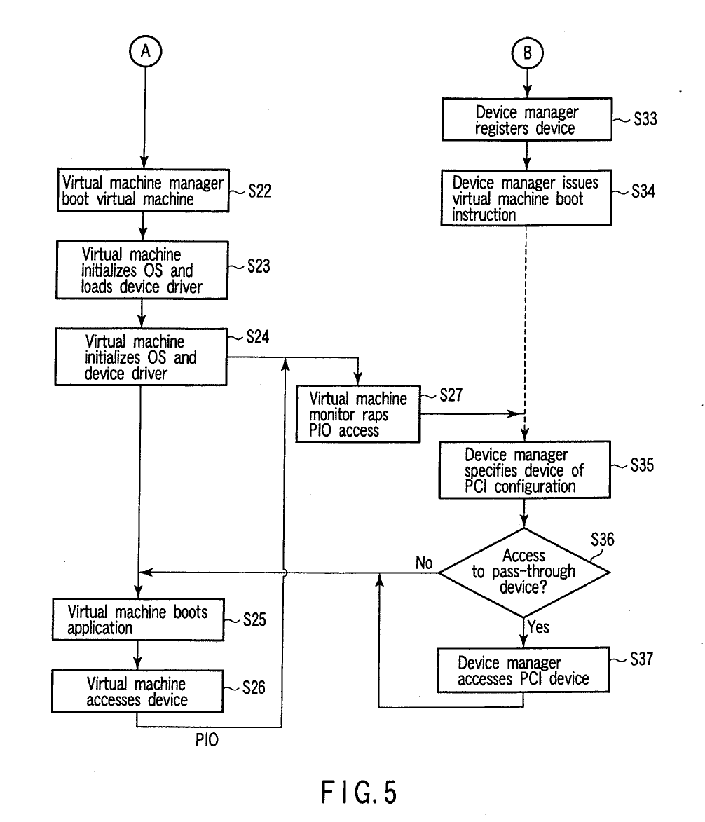

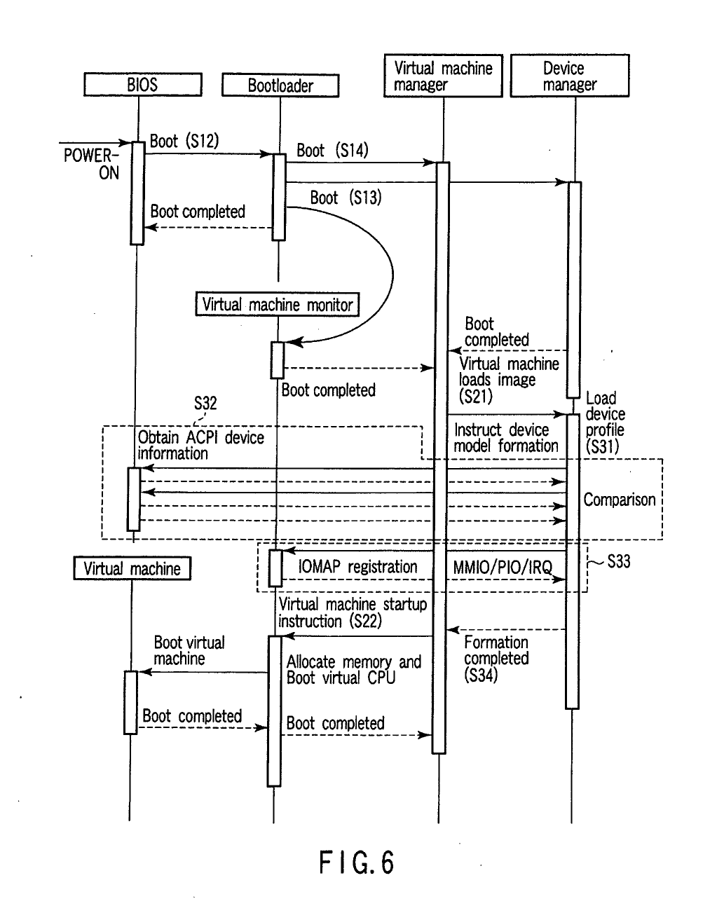

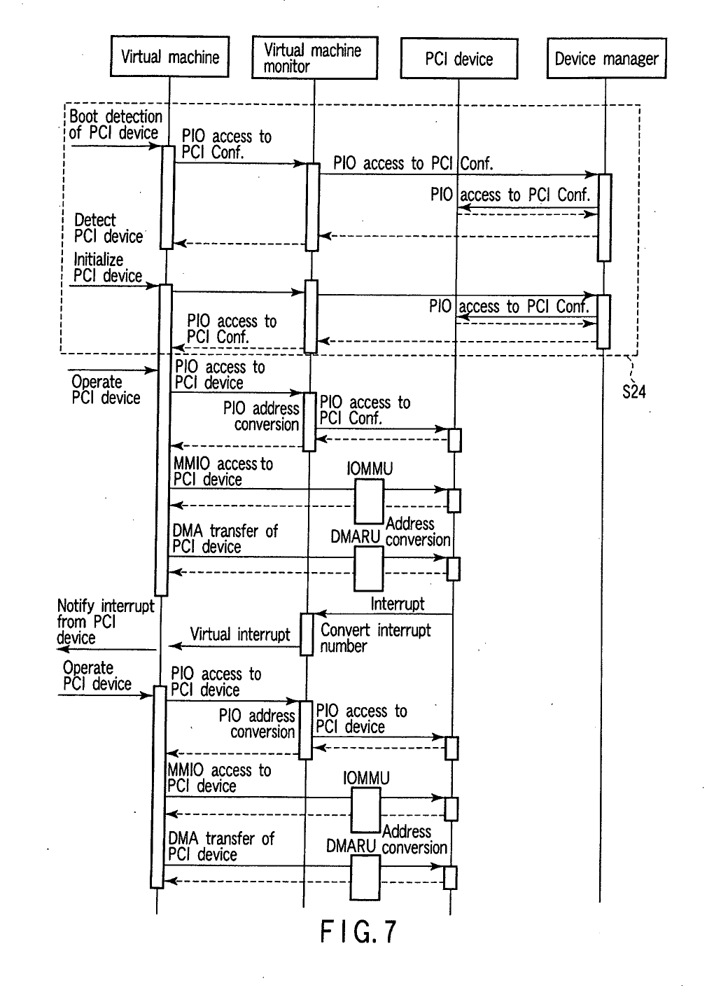

FIGS. 4 through 7 indicate the operation flow from the startup of a client PC (by turning the power switch on) through the implementation of the virtual machine.

When the user presses the power switch down and thereby a wakeup event occurs, the CPU 102 executes a power-on self-test (POST) by the BIOS installed in the BIOS-ROM 109 (Step S11). When the POST is completed, the activated bootloader of the PC of the present embodiment loads and starts the virtual machine manager 210, the device manager 220 and the virtual machine monitor 230 (Step S14), although a conventional bootloader would load the OS first.

When a command of booting the virtual machine (the same command as the regular OS startup), the virtual machine manager 210 determines the information of the to-be-booted user (Step S15). After the user is determined based on the ID of the PC and the preset user name, the virtual machine manager 210 downloads the software image 242 of the virtual machine from the server 240 by way of the LAN (Step S21). It should be noted that the entire software image does not have to be loaded, but only the loader, the system file, the driver and the like that are necessary for the initial boot-up of the virtual machine are loaded. At the same time, the virtual machine manager 210 sends an instruction to the device manager 220 to constitute a device that is suitable for the user.

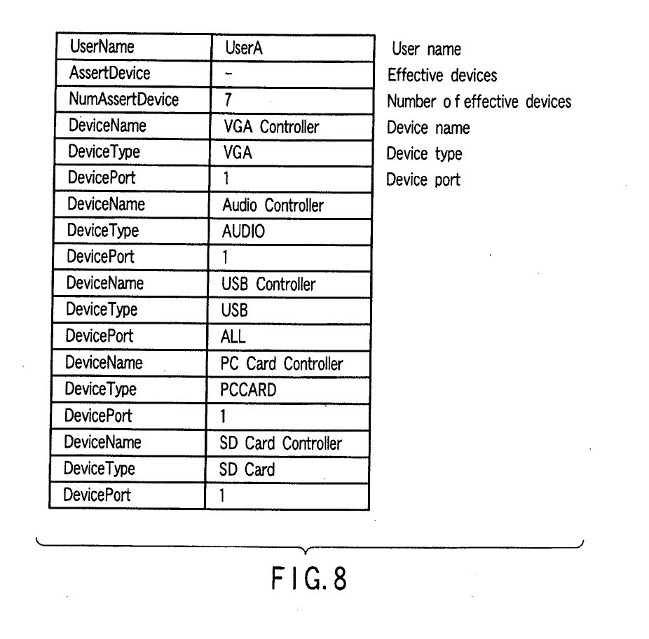

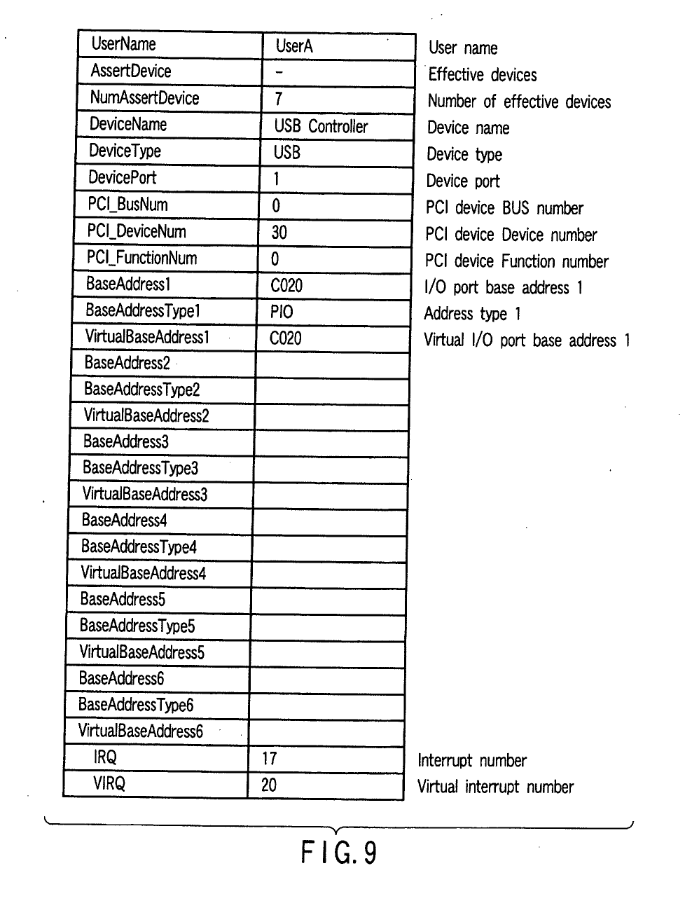

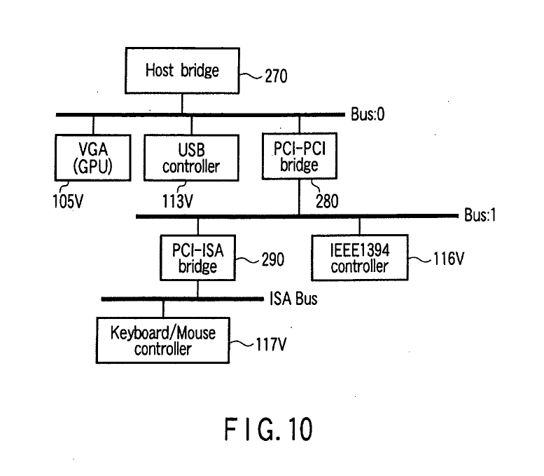

The device manager 220 loads a device profile 250 from the user information (Step S31), and constitutes a device model 211 in accordance with the device profile 250 (Step S32). An example of the device profile 250 is shown in FIG. 8. The device model is formed by a device model generation module 221, which obtains actual hardware device information of the client PC from the ACPI information of the BIOS, and compares it with the profile information. For example, when the ACPI information indicates that a USB device is incorporated, the device model generation module 221 searches through the profile information for a list on which the DeviceType is “USB”. When there is a list containing “USB”, a device model constitution list as shown in FIG. 9 is formed so that the virtual machine will use this USB device. If such a device is contained in the ACPI information but a device of the same type is not contained in the device profile, it is not added to the device model constitution list. Likewise, a device is not added when it is contained in the device profile but not in the ACPI information. When all the devices are checked, a virtual device model as indicated in FIG. 10 is completed. As shown in this drawing, a graphics processing unit 105V, a USB controller 113V, and a PCI-PCI bridge 280 are connected to the host bridge 270 by way of the bus 0. An IEEE 1394 controller 116V is connected to the PCI-PCI bridge 280 by way of the bus 1. An ISA bus is connected to the bus 1 by way of a PCI-PCI bridge 290. A keyboard/mouse controller 117V is connected to the ISA bus.

The device manager 220 registers a device for the virtual machine monitor 230 in accordance with the device model constitution list of FIG. 9 (Step S33). During the registration, the device manager 220 notifies the virtual machine monitor 230 of the PCI device BUS Number, PCI device Device Number, PCI device Function Number, I/O port address (PIO and MMIO) that is to be used, IOMAP information of the virtual I/O port address (PIO and MMIO), interrupt number (IRQ), and virtual interrupt number (VIRQ).

When the registration is completed, the device manager 220 issues an instruction of starting the virtual machine 200 to the virtual machine manager 210 (Step S34). In response to the instruction, the virtual machine manager 210 starts up the virtual machine downloaded from the server 240 (Step S22). The activated virtual machine 200 executes loading of a device driver (Step S23) and initialization of the device driver (Step S24) during the initialization implemented when starting up the operating system (OS). After the operating system starts operating, an application is started in the virtual machine (Step S25). The virtual machine monitor traps an access during the initiation of the device driver or when a PIO access is made from the application (Step S27).

When an access is made from the virtual machine 200 to the PCI configuration space of the PCI device or when an interrupt or access is made to the I/O port due to the IOMAP registration, the virtual machine monitor 230 traps the access (Step S27) and converts the address to a registered address to make an access.

Regarding accesses to the I/O port, when an access is made to the PCI configuration space, the virtual machine monitor 230 calls up the device manager 220 so that the device manager 220 makes an access to the PCI configuration space in place thereof. There are two possible methods of making an access that the device manager 220 can adopt. For this reason, the device manager has to specify a device for the access to the PCI configuration (Step S35). Then, whether or not the access to the specified device is an access to a pass-through device is determined (Step S36). When an access is to be made to a pass-through device (YES in Step S36), the device manager makes an access to the configuration space of the actual PCI device (Step S37). When it is not an access to a pass-through device (NO in Step S36), a read/write operation is performed onto a dummy area generated in the device manager 220 by copying the configuration space, for a device that does not have to be directly accessed or a device that is shared by another virtual machine.

For the MMIO and DMA transfer, the address conversion unit 260 converts, in response to a request from a virtual machine, a virtual physical address to a machine address in accordance with the address conversion information and thereby makes an access. The address conversion unit 260 is provided in a device that has a memory controller. The address conversion unit 260 comprises an I/O memory management unit (IOMMU) 261 and a DMA remapping unit (DMARU) 262. The I/O memory management unit (IOMMU) 261 is utilized when the virtual machine 200 accesses the MMIO area on the main memory. In this case, the operation is regarded, from the virtual machine side, as being conducted by use of a regular device. Thus, the operation can be conducted from the virtual machine by directly using the device driver of the virtual machine.

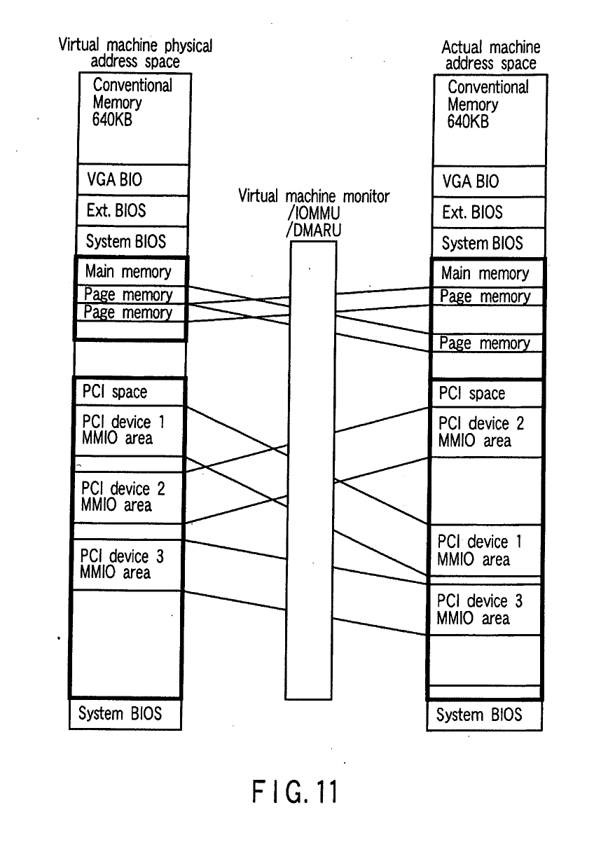

The DMARU 262 is utilized when a DMA is transferred to a memory space assigned to the virtual machine 200. FIG. 11 shows address conversion. As shown in this drawing, the virtual machine monitor, the I/O memory management unit (IOMMU) 261 and the DMA remapping unit (DMARU) 262 perform conversion between the page memory and the MMIO areas of the PSI devices 1, 2 and 3 on the physical address space of the virtual machine, and the page memory and the MMIO areas of the PCI devices 1, 2 and 3 on the address space of the actual machine.

Through such a conversion, when the virtual machine accesses a device when probing (searching for) a PCI or a legacy device at the startup, the access is made not to a device of an actual machine but to a device of the virtual device model of FIG. 10. The virtual machine is activated with the device structure of this model.

On the client computer side, the virtual machine monitor and the device manager assign a mappable device directly to a virtual machine, and address conversion between the actual memory space and the memory space of the virtual machine is conducted by the hardware. This dramatically improves the I/O performance and operability of the virtual machine. As a result, high-speed graphic rendering such as rendering by an application dealing with multimedia and CAD can be realized.

The present embodiment does not require the I/O emulation of the virtual machine. Thus, a device that could not be adopted by the conventional technology because of the emulator having no provision for the device becomes usable from the virtual machine by directly using the device driver of the virtual machine.

A device profile is prepared for every user so that available I/O devices are designated. I/O devices recognizable from the OS (virtual machine) are limited so that the user is not permited to operate a device by intentionally installing a device driver or the like. Thus, security measures useful in prevention of information leakage can be achieved.

Moreover, the server has a virtual machine image, and a client computer activates a machine from the unified image. Thus, the setting of the OS and applications and corrections by HotFix or the like do not have to be performed for each user. This means that the cost of managing client computers can be reduced.

Even when the hardware of the computer is changed by loading and activating the image of the virtual machine onto a different server, the environment setting for each user does not require installing or re-setting operations.

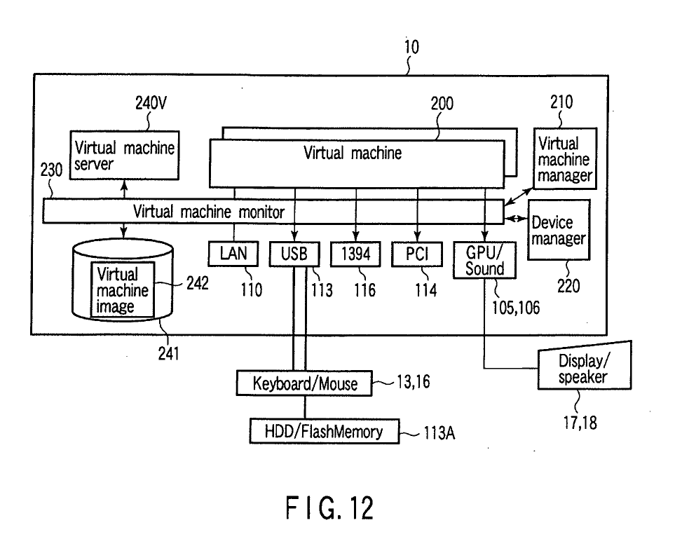

According to the present embodiment, an example includes a server and a client computer connected to each other by way of a network. However, as illustrated in FIG. 12, the server that manages the image of the virtual machine may be operated as a virtual machine on the client computer.

By operating the image of the virtual machine from the server as a virtual machine running on a client computer, the aforementioned effects can be attained on a single computer, and this machine can be dealt with in the same manner as a regular computer.

The various modules of the systems described herein can be Implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus in which virtual machines including a client virtual machine run under a hypervisor, comprising:
a device manager configured to create a device model including information that is used when assigning an I/O device to the client virtual machine in accordance with a device profile and an arrangement of I/O devices provided in the information processing apparatus; and
a semiconductor circuit having an address conversion circuit configured to perform address conversion for the client virtual machine to make an MMIO access to the assigned I/O device and to perform address conversion to conduct a DMA transfer between the assigned I/O device and the client virtual machine,
wherein the hypervisor assigns the I/O device to the client virtual machine based on the device model, and
the client virtual machine utilizes, when making the MMIO access to the assigned I/O device or conducting the DMA transfer with the assigned I/O device, the address conversion circuit to make the access or conducts the DMA transfer.

2. The information processing apparatus of claim 1, wherein
the device profile is prepared for each user of the information processing apparatus, and
the device manager creates the device model in accordance with the device profile corresponding to the user.

3. The information processing apparatus of claim 2, wherein
the device manager regulates an access from the virtual machine to the I/O device arranged in the information processing apparatus in accordance with the device profile.

4. The information processing apparatus of claim 1, wherein
the client virtual machine is activated on the hypervisor when an image of the virtual machine is loaded from a server.

5. The information processing apparatus of claim 4, wherein the server is a virtual machine running under the hypervisor.

6. A method of controlling an information processing apparatus in which virtual machines including a client virtual machine run under a hypervisor, comprising:
creating a device model including information that is used when assigning an I/O device to the client virtual machine in accordance with a device profile and an arrangement of I/O devices provided in the information processing apparatus;
assigning the I/O device to the client virtual machine in accordance with the device model by the hypervisor; and
making an MMIO access to the assigned I/O device or conducting a DMA transfer with the assigned I/O device by the client virtual machine, by use of an address conversion circuit configured to perform address conversion for the client virtual machine to make the MMIO access to the assigned I/O device or to conduct the DMA transfer between the assigned I/O device and the client virtual machine.

7. The method of controlling the information processing apparatus of claim 6, wherein
the device profile is prepared for each user of the information processing apparatus, and
a device manager creates the device model in accordance with the device profile corresponding to the user.

8. The method of controlling the information processing apparatus of claim 7, wherein the device manager regulates an access from the virtual machine to the I/O device in accordance with the device profile.

9. The method of controlling the information processing apparatus of claim 6, wherein the client virtual machine is activated on the hypervisor when an image of the virtual machine is loaded from a server.

10. The method of controlling the information processing apparatus of claim 9, wherein the server is a virtual machine running under the hypervisor.
